(19) United States
(12) Patent Application Publication
(10) Pub. No.: US 2017/0067531 A1
(43) Pub. Date: Mar. 9, 2017

(54) Mount for High Vibration Environment

(71) Applicant: Vega Americas, Inc., Cincinnati, OH (US)

(72) Inventors: Shawn Gregory Ahlers, Mason, OH (US); Esther Milagros Díaz Rivera, Mason, OH (US); Christopher Hamilton Willoughby, Loveland, OH (US)

(21) Appl. No.: 15/120,626

(22) PCT Filed: Feb. 23, 2015
(86) PCT No.: PCT/US15/17081

§ 371 Date: Aug. 22, 2016

Related U.S. Application Data
(60) Provisional application No. 61/943,292, filed on Feb. 21, 2014.

(51) Int. Cl. F16F 15/02; F16F 1/37; G01D 11/30; F16M 13/02

(52) U.S. Cl. CPC F16F 15/02; F16M 13/02; F16F 1/37; G01D 11/30; F16F 2224/0225; F16M 2200/00

(57) ABSTRACT

A mechanically isolating mounting for use with a level sensing gauge (12) comprises damping material (22a, 22b) positioned exterior to the metal primary housing and between a primary housing of the gauge and a gauge mounting (13, 20, 20a), such that the damping material isolates the gauge mechanically from vibration and shock delivered through the gauge mounting. The gauge housing may comprise a mounting plate (13) or a metal enclosure (20, 20a) surrounding the primary housing and forming an outer housing.

### RELATED APPLICATIONS

The application claims priority to U.S. Provisional Application Ser. No. 61/943,292 filed Feb. 21, 2014, which is incorporated herein in its entirety.

### FIELD OF THE INVENTION

The present invention relates to mountings for level sensing gauges.

### BACKGROUND OF THE INVENTION

Level sensing gauges are applied in many industrial environments and are typically designed to handle harsh process conditions and environments, including long term chemical exposure, extreme cold or heat and in some cases outdoor weather. Recently, however, these devices have become of interest for use in oil drilling and particularly fracking operations, which generate very high mechanical stress and vibration of a kind not experienced in even the harshest environments for which the gauges were designed. The failure rate of the sensitive electronics in the gauges has proven to be unacceptably high in these environments.

### SUMMARY OF THE INVENTION

The present invention provides a novel mounting for a level sensing gauge that provides greater vibration and mechanical shock protection than has been afforded by any known prior system. Specifically, the invention in its two embodiments shields the gauge from vibration via a heavy thick layer of insulating foam that sits between the outer housing of the gauge and the mounting plates that mechanically couple to the well-connected equipment that is subjected to mechanical shock, e.g. mechanical shock produced for fracking.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 illustrates a first embodiment of the invention in which a level sensing gauge is mounted to a mounting plate by U-bolts, but is mechanically isolated from the mounting plate by a thick layer of damping foam sandwiched between the outer housing of the gauge and the mounting plate.

FIG. 2 is a disassembled perspective view of this first embodiment showing the mounting plate, damping foam on the upper side of the mounting plate, the gauge, and the U-bolts.

FIG. 3 is a perspective view of a second embodiment of the invention in which a level sensing gauge is entirely encased in a second housing surrounding the primary gauge housing.

FIG. 4 is a disassembled perspective view of this second embodiment showing the two parts of the outer housing, the gauge, and the conforming damping form the encapsulates the main housing of the gauge and isolates the gauge mechanically from the outer housing.

FIG. 5 is a cross section along lines 5-5 of FIG. 3 showing the encapsulation of the gauge main housing inside of the isolating damping foam, which is itself captured within the outer housing.

### DETAILED DESCRIPTION OF THE INVENTION

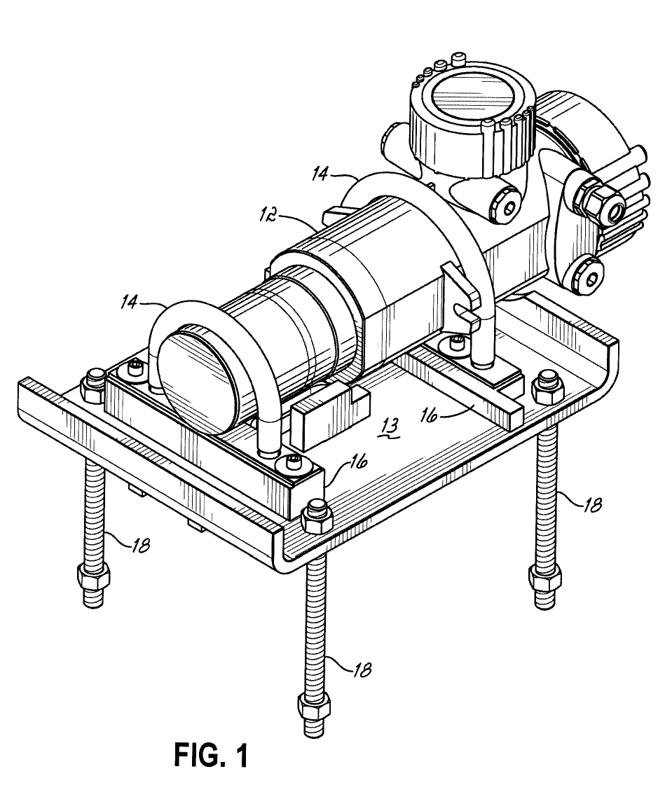

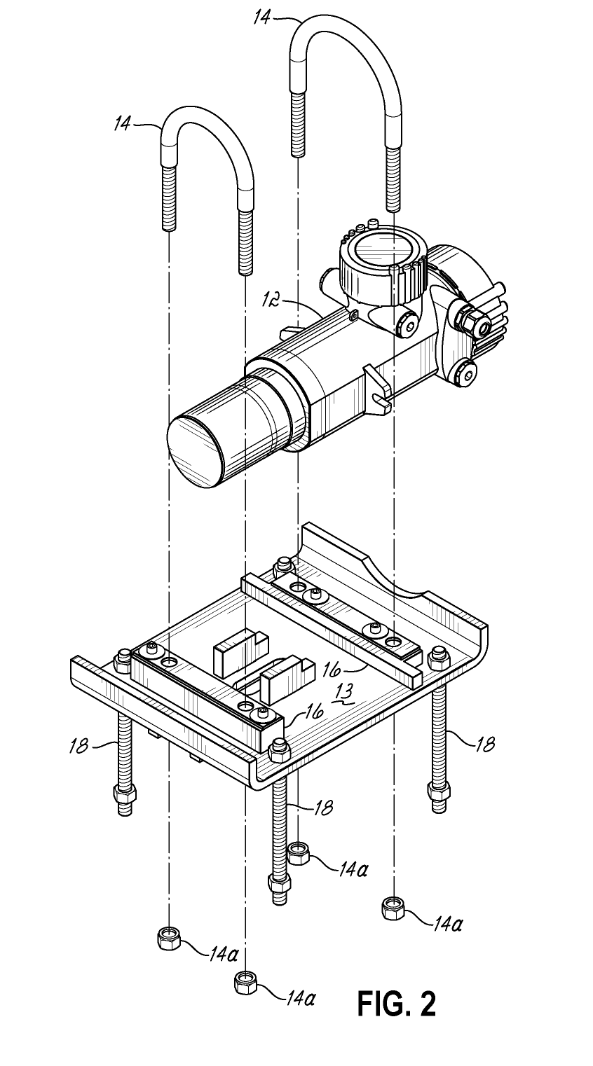

FIG. 1 and FIG. 2 illustrate a level sensing gauge 12 mounted to a mounting plate 13 by U-bolts 14, which are held firmly to mounting plate 13 by nuts 14a (FIG. 2). Level sensing gauge 12 is mechanically isolated from the mounting plate 13 by a thick layer of damping foam 14 sandwiched between the outer housing of the gauge and the mounting plate. The mounting plate 13 is mounted to surrounding structure via mounting bolts 18.

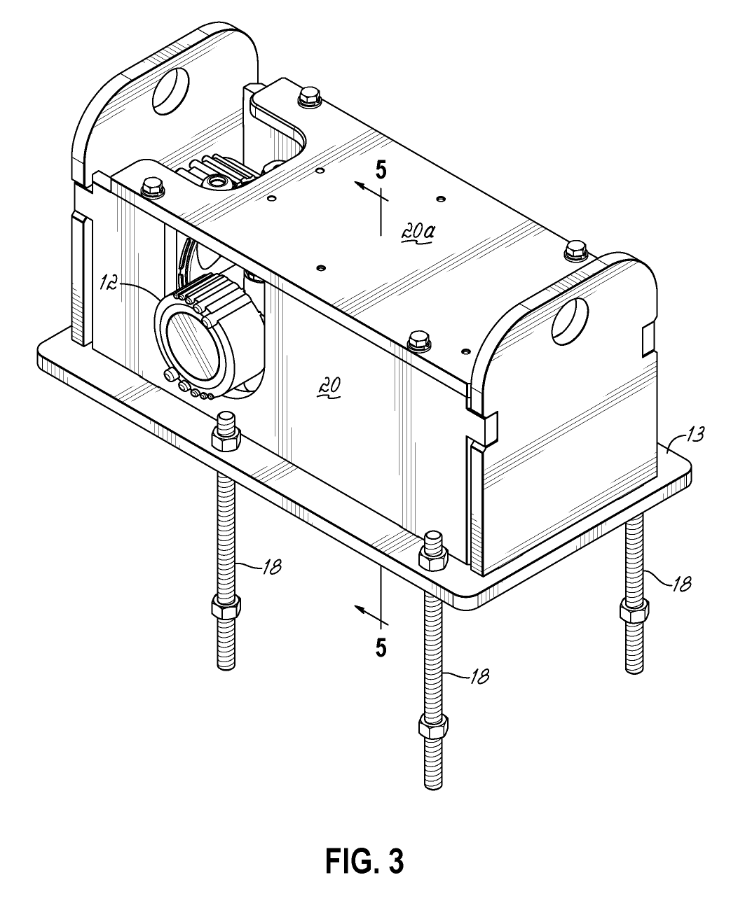

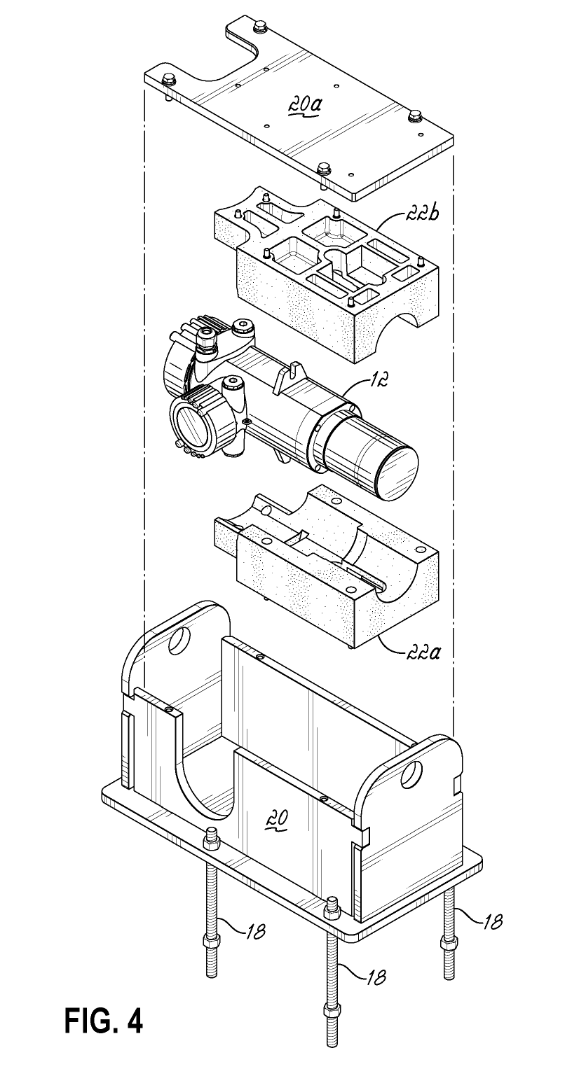

FIGS. 3 and 4 are perspective views of an embodiment of the invention in which a level sensing gauge 12 is mounted to a mounting plate 13 similar to that shown in FIGS. 1 and 2, and entirely encased in an outer housing, comprising a body 20 and cover 20a. The outer housing 20/20a surrounds the primary housing of the gauge 12, thus forming a double housing. Within the outer housing, the gauge 13 is surrounded by conforming damping foam sections 22a and 22b which encapsulates the primary housing of the gauge and isolates the gauge mechanically from the outer housing 20/20a.

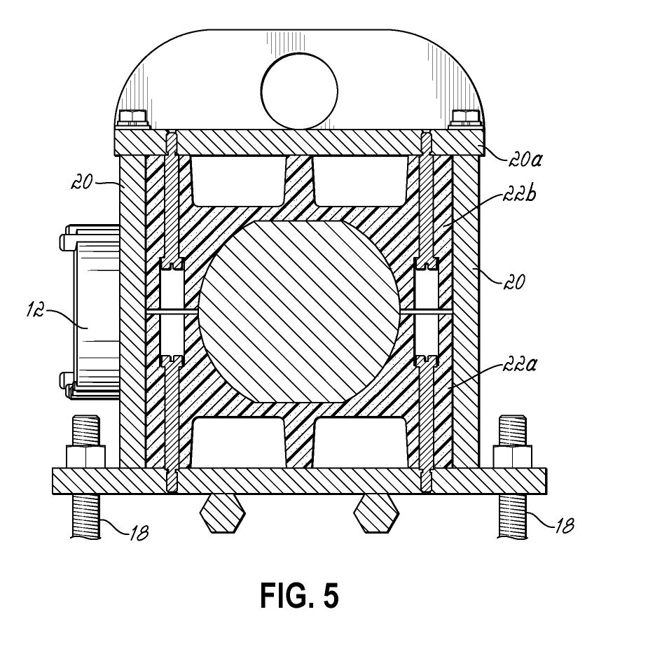

FIG. 5 is a cross section along lines 5-5 of FIG. 3 showing the encapsulation of the primary housing of the gauge 13 inside of the isolating damping foam 22a and 22b, which is itself captured within the outer housing 40/40a.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A mechanically isolating mounting for use with a level sensing gauge having a metal primary housing, the isolating mounting comprising damping material positioned exterior to the metal primary housing and between the metal primary housing and a gauge mounting, such that the damping material isolates the gauge mechanically from vibration and shock delivered through the gauge mounting.

2. The mounting of claim 1 wherein the gauge housing comprises a metal enclosure surrounding the primary housing and forming an outer housing.

3. The mounting of claim 1 wherein the damping material comprises a damping foam mounted between the metal primary housing and gauge mounting.

4. The mounting of claim 1 wherein the damping material substantially surrounds the metal primary housing.

5. The mounting of claim 2 wherein the damping material substantially surrounds the metal primary housing.

6. The mounting of claim 5 wherein the damping material comprises a damping foam mounted between the metal primary housing and gauge mounting.
